(19) United States
(12) Patent Application Publication
(10) Pub. No.: US 2013/0303200 A1
(43) Pub. Date: Nov. 14, 2013

(54) Location Server Method for Communicating Location Information

(71) Applicants: Andreas Hansson, Karlskrona (SE); Liang Shi, Shanghai (CN); Torbjörn Wigren, Uppsala (SE)

(72) Inventors: Andreas Hansson, Karlskrona (SE); Liang Shi, Shanghai (CN); Torbjörn Wigren, Uppsala (SE)

(73) Assignee: Telefonaktiebolaget L M Ericsson (publ), Stockholm (SE)

(21) Appl. No.: 13/981,182

(22) PCT Filed: Jan. 25, 2011
(86) PCT No.: PCT/SE11/50071

§ 371 Date: Jul. 23, 2013

(51) Int. Cl. H04W 24/00

(52) U.S. Cl. CPC H04W 24/00
USPC 455/456.5

(57) ABSTRACT

A location server (2) for a mobile telecommunications network (1), the location server (2) comprising at least one network interface (3) through which it is arranged to communicate with network nodes (4) of the mobile telecommunications network (1), and a processor (5) arranged to: receive a message containing information from which the position of a mobile device (6) of the telecommunications network (1) can be estimated; process the information to produce a mobile device (6) position estimate; send to at least one of the network nodes (4, 6) an output message containing the estimate; and quantize the information to have one of a plurality of indicative values, each of the values indicating a range of distances having upper and lower bounds, wherein, for at least some successive pairs of the indicative values, for indicative values indicating increasing distance, the difference between the upper and lower bounds increases, typically exponentially.

### TECHNICAL FIELD

This invention relates to a location server for and a method of communication information concerning the location of mobile devices in a radio telecommunications network.

### BACKGROUND

Location-based services have become an important source of revenue for operators of mobile telecommunications networks, and a number of different applications are available and largely used. The location-determining functions of a network can be implemented by means of a location server, such as the Serving Mobile Location Centre (SMLC) of Global System for Mobile Communications (GSM). This server handles position measurements and the calculation of the position of mobile telecommunications devices with the network.

FIG. 5 shows part of the functioning of the Adaptive Enhanced Cell Identification (AECID) fingerprinting positioning system proposed by Ericsson, as used with GSM. Whenever a high precision A-GPS (assisted-global positioning system) measurement is received from a mobile device, the cell global identity (CGI) of the cell receiving the measurement and its neighbouring cells that are detectable are sampled, the time of flight (or timing advance, TA) is retrieved, and the signal strengths are measured. The list of CGIs, the TA, the signal strength measurements and the high precision A-GPS measurements are forwarded to a clustering block 100.

The clustering block 100 collects high precision A-GPS position measurements as reference points in clusters, where each cluster corresponds to a specific (ordered) list of CGIs, a TA and quantized signal strength measurements. This information is denoted the tag. Clusters of A-GPS position measurements that are associated with a region where a specific set of cells can be detected and where the TA and signal strengths have specific values are hence created automatically. When a sufficient amount of reference points have been collected in a cluster, a reportable polygon that describes the boundary of the tagged cluster is computed (102).

When a positioning request is received in the positioning node, the list of own and neighbour CGIs and the TA are retrieved, and signal strength measurements are performed and quantized. This information creates the tag of the terminal. The polygon that corresponds to the tag is collected from the database (104), and reported as the positioning result.

Problems can occur when time of flight, round trip time or TA tagging is used when cells become large:
The number of round trip time/TA regions, and hence fingerprints, become large since this number is roughly given by the quotient between the radius of the cell and the radial thickness of the TA region, determined by the TA granularity in the GSM standard.
Due to the large number of regions the time it will take to populate them with fingerprinted high precision measurements (A-GPS) also becomes unacceptably large.
Due to the large quotient between the lateral extension and the radial extension (the thickness), the polygon format that is computed by the AECID algorithm, to describe each fingerprinted region becomes insufficient, resulting in a reduced accuracy. This follows since the polygon is standardized (in the Long Term Evolution or LTE project) by the Third Generation Partnership Project (3GPP) to contain a maximum number of 15 corners. The same or similar constraints are in place for the GSM and wideband code division multiple access (WCDMA) cellular systems.

### SUMMARY

According to a first aspect of the invention we provide a location server for a mobile telecommunications network, the location server comprising at least one network interface through which it is arranged to communicate with network nodes of the mobile telecommunications network, and a processor arranged to:
receive using the or each network interface from the network nodes at least one input message containing information from which the position of a mobile device of the telecommunications network can be estimated;
process the information so as to produce an estimate of the position of the mobile device;
send using the or each network interface to at least one of the network nodes at least one output message containing the estimate; and
quantise the information to have one of a plurality of indicative values, each of the values indicating a range of distances having upper and lower bounds, wherein, for at least some successive pairs of the indicative values, for indicative values indicating increasing distance, the difference between the upper and lower bounds increases.

Thus, larger quanta are used at larger distances, thus reducing the number of areas required. Measurements at longer distances are likely to be more inaccurate, making smaller bands at higher distances less worthwhile.

Furthermore, given that the distance is likely to be being measured from a base station or other similar node in the network, which are generally (although not exclusively) in areas where there are likely to be many mobile devices, in some situations it will be likely that there will generally be more mobile devices at low distances, and fewer at high distances; the average quantisation error may therefore be less.

Preferably, the increase is at least partially exponential. For a plurality of the indicative values at least one of the upper and lower bounds may be calculated according to an exponential term. Typically, the indicative value is a number, and for a plurality of the indicative values at least one of the upper and lower bound depends exponentially on a term dependent on the number.

The location server may comprise storage, the processor being arranged so as to store a database in the storage, the database containing the information and the estimate for a plurality of mobile devices.

The location server may comprise a first network node comprising the storage on which the database is stored, and a second node comprising the processor. In such a case, the second network node may be arranged to send the first network node a message comprising the quantised information.

The first network node may be arranged to send the second network node a message comprising a quantisation scheme, the quantisation scheme comprising an indication of the ranges corresponding to each value.

The information may comprise data indicative of at least one of position data derived from location satellites, the time taken for radio signals to pass between a network node and the mobile device, the signal strength received at a network node from the mobile device or vice versa, the path loss between a network node and the mobile device.

The estimate may comprises a representation of a polygon inside which the mobile device is expected to be found, the polygon comprising vertices each having a position, the quantisation being in the position of the vertices of the polygon.

According to a second aspect of the invention, there is provided a method of communicating information concerning the location of mobile devices in a radio telecommunications network, each mobile device being in radio contact with a base station of the radio telecommunications network, the method comprising:
the location server receiving characteristics indicative of the position of the mobile devices;
the location server processing the characteristics so as to produce an estimate of the position of the mobile devices;
the location server transmitting the estimates of the position of the mobile devices to network nodes of the radio telecommunications network

in which the method comprises quantising the characteristics to have one of a plurality of indicative values, each of the values indicating a range of distances having upper and lower bounds, wherein, for at least some successive pairs of the indicative values, for indicative values indicating increasing distance, the difference between the upper and lower bounds increases.

The quantisation may be at least partially exponential or an approximation thereto. Typically, for a plurality of the indicative values at least one of the upper and lower bound is calculated according to an exponential term.

The indicative value may be a number, and for a plurality of the indicative values at least one of the upper and lower bound may depend exponentially on a term dependent on the number.

The method may comprise storing a database containing the information and the estimate for a plurality of mobile devices on a first network node of the location server, the processor being on a second network node, the first and second network nodes sending each other messages comprising the information or the estimates as quantised. Alternatively, a database containing the information and the estimate for a plurality of mobile devices may be on the same network node as the processor.

### BRIEF DESCRIPTION OF THE DRAWINGS

FIG. 1 shows a network according to a first embodiment of the invention;

FIG. 2 shows a network node of the network of FIG. 1;

FIG. 3 shows a method carried out by the network of FIG. 1;

FIG. 4 shows a network according to a second embodiment of the invention; and

FIG. 5 shows an adaptive enhanced cell identification (AECID) server discussed in the background section above.

### DETAILED DESCRIPTION

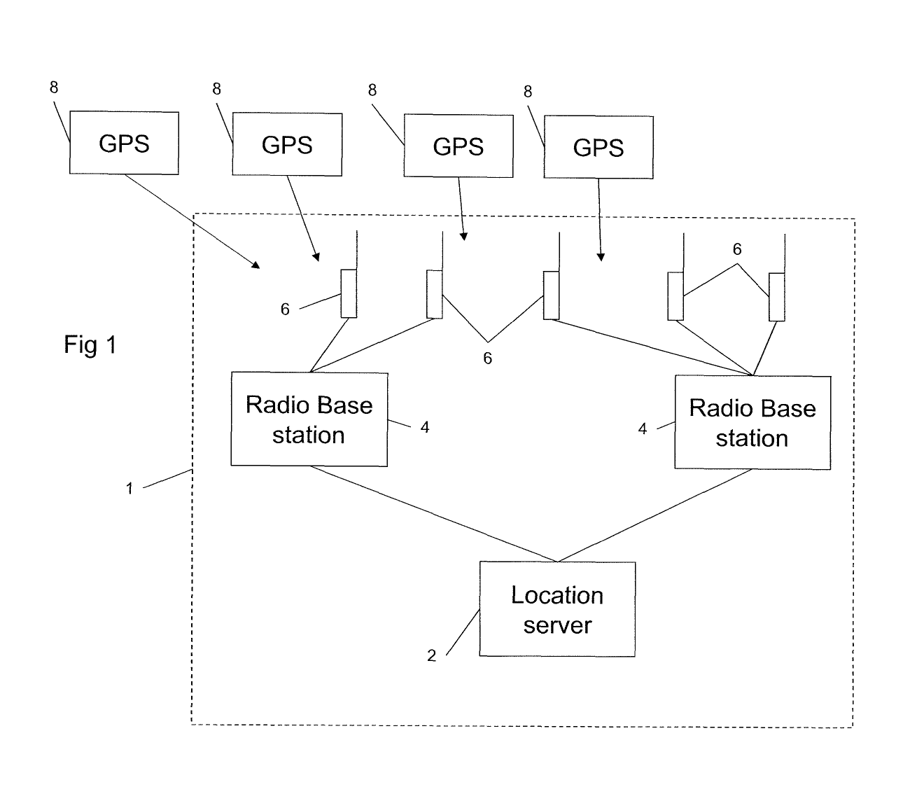

A network according to a first embodiment of the invention is shown in FIGS. 1 to 3 of the accompanying drawings. This network 1 is depicted in general form; the skilled reader will appreciate that the network could be implemented in GSM (Global System for Mobile Communications), WCDMA (Wideband Code Division Multiple Access), LTE (Long Term Evolution), or any other network that has the location features set out below.

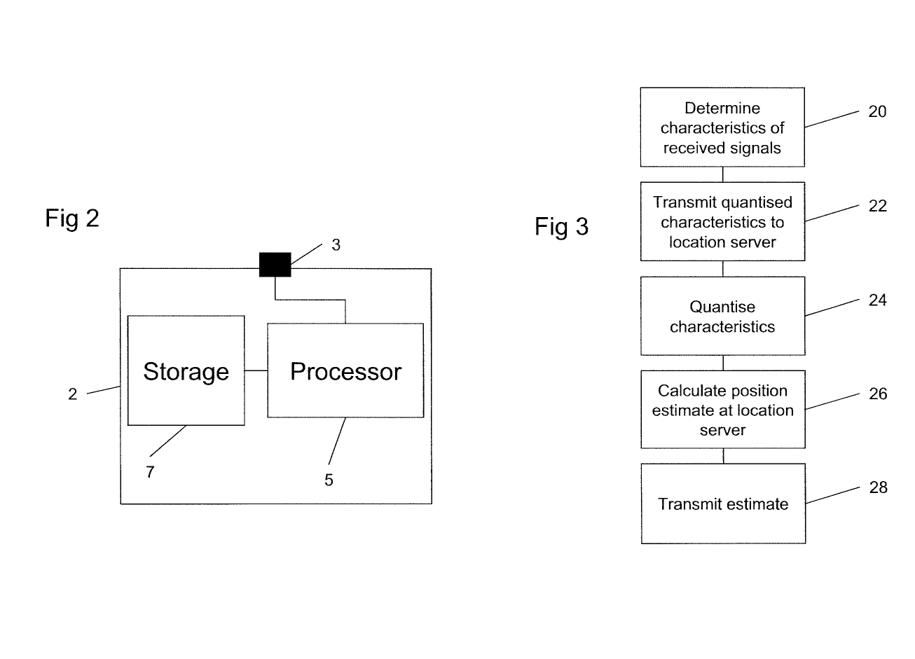

The network comprises a plurality of mobile telecommunication device 6, typically referred to as user equipment (UE). These are connected by radio transmissions to radio base stations 4. The radio base stations 4 are also connected to a location server 2, which is shown in more detail in FIG. 2. The location server 2 collects and processes data concerning the position of the mobile telecommunication devices 6 for use both by the mobile telecommunication devices and the network 1 as a whole.

One method of determining the position of the mobile telecommunication devices 4 is to use a measure of the time of flight of the radio signals between the mobile telecommunications devices 6 and the radio base stations 4. This is referred to as Timing Advance (TA) in GSM or LTE and Round Trip Time (RTT) in WCDMA. Time of flight is a measure of the distance, as the radio transmissions will travel at the speed of light in the local medium (presumed to be air, and therefore only very slightly less than that in a vacuum) of 3.00×10⁸ metres per second.

This time of flight data between each mobile telecommunications device 6 and the radio base station(s) 4 it is contact with is measured (step 20 in FIG. 3) either at the radio base station(s) 4 or the mobile telecommunications device 6 and passed (step 22 in FIG. 3), together with identifying data, through the network to the location server 2. The signal strength received at either the radio base station 4 or the mobile telecommunications device 6 for each active pairing is also transmitted. It can be noted that in most systems the two way time of flight is measured—then a division by two is needed to obtain the one way time of flight. Compensation for latencies in the telecommunication devices may also be needed, e.g. in the WCDMA cellular system.

The location server 2 receives this data through network interface 3 and processes it in processor 5. In order to reduce the complexity of the calculations and data storage required by the location server 2, the location server quantises (step 24) this time of flight data. The quantisation replaces the raw time of flight data into a number indicative of a range of distances. In order to keep the number of discrete values possible manageable, and to provide a quantisation table that is equally suitable to dense urban, urban and rural environments, the range of each discrete value increases with the distance from the radio base station. Whilst the closer, lower, values are set manually as shown in the table below, valid for an example embodiment, larger values are chosen so that the bounds of each value vary exponentially. The following Table 1 gives an example of the quantisation used for GSM.

TABLE 1

| Discrete | | |
|---|---|---|
| value | Lower bound (m) | Upper bound (m) |
| 0 | 0 | 100 |
| 1 | 100 | 200 |
| 2 | 200 | 300 |
| 3 | 300 | 450 |
| 4 | 450 | 650 |
| 5 | 650 | 850 |
| 6 | 850 | 1100 |
| 7 | 1100 | 1400 |
| 8 | 1400 | 1700 |
| 9 | 1700 | 2000 |
| 10 | 2000 | 2000 × 1.15 = 2300 |
| 11 | 2000 × 1.15 = 2300 | 2000 × 1.15² = 2645 |
| . | . | . |
| . | . | . |
| . | . | . |
| N | 2000 × 1.15^{N-10} | 2000 × 1.15^{N-9} |
| . | . | . |
| . | . | . |
| . | . | . |
| 42 | 2000 × 1.15³² = 175130 | 200000 |

Note that the table consists of less than 50 values, yet it covers a range of 200 km and allows for high accuracy quantization close to the base station. This means that all radio environments (dense urban, urban, suburban and rural) can be covered by a single quantization table, allowing for the handling of the quantization table at positioning node level, rather than at cell level. This is a significant advantage since the number of cells can approach 1 million in large telecommunication networks.

For LTE, a different quantisation table can be used, as follows in Table 2:

TABLE 2

| Discrete | | |
|---|---|---|
| value | Lower bound (m) | Upper bound (m) |
| 0 | 0 | 250 |
| 1 | 250 | 500 |
| 2 | 500 | 750 |
| 3 | 750 | 1150 |
| 4 | 1150 | 1650 |
| 5 | 1650 | 2150 |
| 6 | 2150 | 2800 |
| 7 | 2800 | 3500 |
| 8 | 3500 | 4300 |
| 9 | 4300 | 5000 |
| 10 | 5000 | 5000 × 1.15 |
| 11 | 5000 × 1.15 | 5000 × 1.15² |
| . | . | . |
| . | . | . |
| . | . | . |
| N | 5000 × 1.15^{N-10} | 5000 × 1.15^{N-9} |
| . | . | . |
| . | . | . |
| . | . | . |
| 35 | 5000 × 1.15²⁵ = 164590 | 200000 |

Note that this table consists of less than 40 values, yet it covers a range of 200 km and allows for high accuracy quantization close to the base station. This means that all radio environments (dense urban, urban, suburban and rural) can be covered by a single quantization table, allowing for the handling of the quantization table at positioning node level, rather than at cell level.

Use of either of these quantisation tables can result in:
Radial thicknesses, used for fingerprinting positioning, becoming larger when the distances from the base station become larger.
The time it takes to populate all regions fingerprinted by round trip time being reduced.
The polygon format still being capable of providing a good enough accuracy for said regions fingerprinted by quantized round trip time information.

Once the quantisation has been carried out, the location server 2 stores the quantised data and other position-related data (for example, data relating to the position of the mobile telecommunications devices 4 relative to positioning satellites 8, typically using the Global Positioning System or GPS, received signal strength and so on) in a database held on storage device 7. It also processes all of the position the data using well known methods to determine an estimate (step 26) of the position of the mobile telecommunications devices 6. The estimates can then be transmitted (step 28) using network interface 3 to any other node in the network that desires such information.

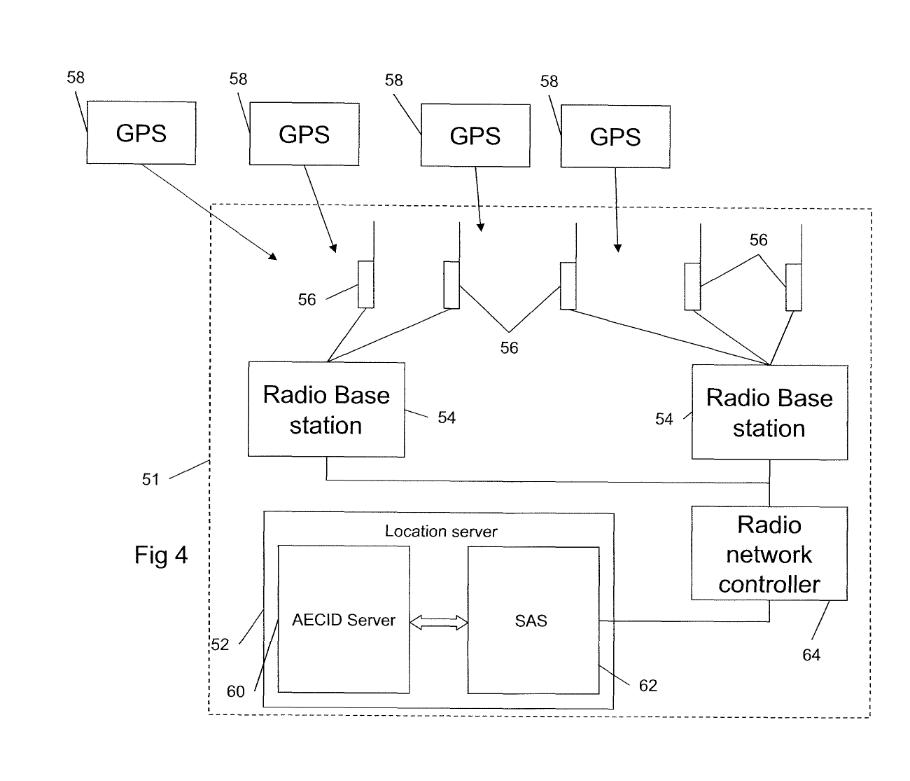

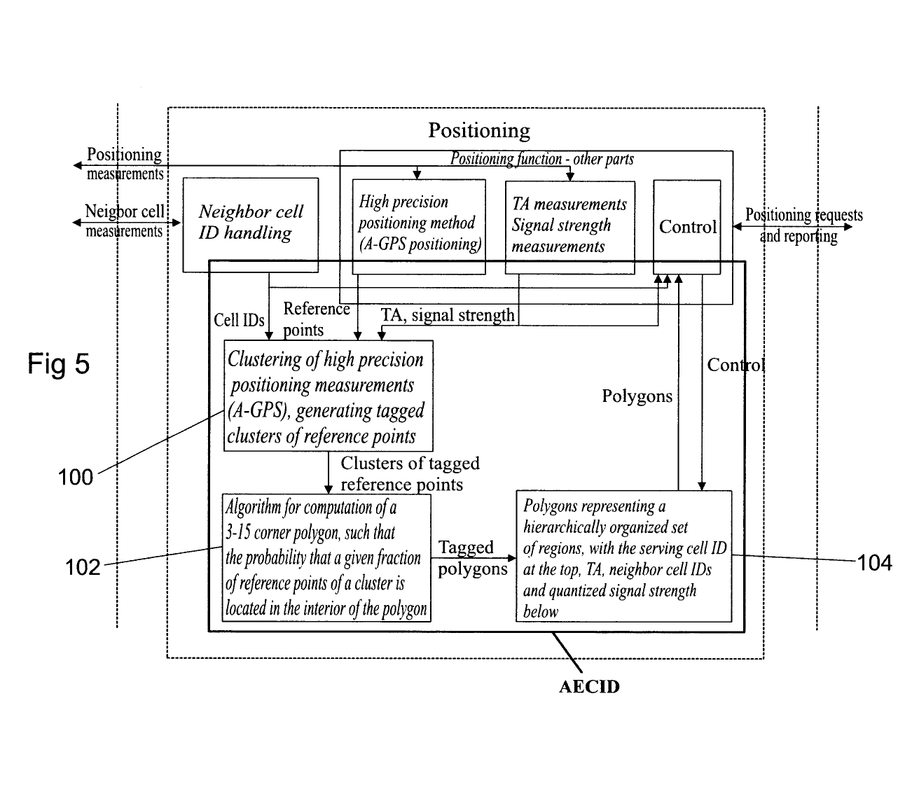

A second embodiment of the invention is shown in FIG. 4 of the accompanying drawings. The embodiment functions broadly as the first embodiment does except where discussed below, and corresponding integers have been given the same reference numerals raised by 50.

In this embodiment, the location server 52 is split into two network nodes; using the terminology of WCDMA, these are the Standalone Serving Mobile Location Centre (SAS) 62 and an Adaptive Enhanced Cell Identification (AECID) server 60. These are connected to the mobile telecommunications devices 56 through a radio network controller (RNC, 64).

The SAS 62 receives and carries out the processing of the position-related data that was carried out by the location server of the first embodiment (and so will be provided with a suitable processor). However, the data itself is stored on a database stored on a storage means (for example, a hard disk) on the AECID server 60. The position data, such as time of flight and received signal strength, is transmitted from the mobile telecommunications devices to the RNC 64 over a Radio Resource Control (RRC) interface, whereas that data is then transmitted on from the RNC 64 to the SAS 62 through a Positioning Calculation Application Part (PCAP) interface.

Once the data has been received by the SAS 64, the SAS will quantise the time of flight data as in the previous embodiment. The quantised time of flight data is sent to the database of the AECID server 60 with the remainder of the data. The data can be retrieved by the SAS 62 from the AECID server 60 when it is desired to calculate the position estimates.

It is to be noted that the quantisation tables (such as tables 1 and 2 above) can be set on the AECID server 60; because one table fits many situations, the AECID server only needs to transmit the table to the SAS 62, rather than having to transmit tailored quantisation tables to many network nodes.

1-15. (canceled)

16. A location server for a mobile telecommunications network, the location server comprising at least one network interface through which it is arranged to communicate with network nodes of the mobile telecommunications network, and a processor arranged to:
receive at least one input message via the at least one network interface, said at least one input message containing information from which the position of a mobile device of the telecommunications network can be estimated;
process the information so as to produce an estimate of the position of the mobile device;
send at least one output message containing the estimate to at least one of the network nodes, said at least one output message sent via the at least one network interface; and
quantise the information to have one of a plurality of indicative values, each of the values indicating a range of distances having upper and lower bounds, wherein, for at least some successive pairs of the indicative values, for indicative values indicating increasing distance, the difference between the upper and lower bounds increases.

17. The location server of claim 16, in which the increase is at least partially exponential.

18. The location server of claim 16, in which for a plurality of the indicative values at least one of the upper and lower bound is calculated according to an exponential term.

19. The location server of claim 16, in which the indicative value is a number, and for a plurality of the indicative values at least one of the upper and lower bound depends exponentially on a term dependent on the number.

20. The location server of claim 16, further comprising storage, the processor being arranged so as to store a database in the storage, the database containing the information and the estimate for a plurality of mobile devices.

21. The location server of claim 20, comprising a first network node comprising the storage on which the database is stored, and a second node comprising the processor.

22. The location server of claim 21, in which the second network node is arranged to send the first network node a message comprising the quantised information.

23. The location server of claim 21, in which the first network node is arranged to send the second network node a message comprising a quantisation scheme, the quantisation scheme comprising an indication of the ranges corresponding to each value.

24. The location server of claim 16, in which the information comprises data indicative of at least one of position data derived from location satellites, the time taken for radio signals to pass between a network node and the mobile device, the signal strength received at a network node from the mobile device or vice versa, the path loss between a network node and the mobile device.

25. The location server of claim 16, in which the estimate comprises a representation of a polygon inside which the mobile device is expected to be found, the polygon comprising vertices each having a position, the quantisation being in the position of the vertices of the polygon.

26. A method of communicating information concerning the location of mobile devices in a radio telecommunications network, each mobile device being in radio contact with a base station of the radio telecommunications network, the method comprising:
the location server receiving characteristics indicative of the position of the mobile devices;
the location server processing the characteristics so as to produce an estimate of the position of the mobile devices;
the location server transmitting the estimates of the position of the mobile devices to network nodes of the radio telecommunications network; and
wherein the method includes quantising the characteristics to have one of a plurality of indicative values, each of the values indicating a range of distances having upper and lower bounds, wherein, for at least some successive pairs of the indicative values, for indicative values indicating increasing distance, the difference between the upper and lower bounds increases.

27. The method of claim 26, in which the quantisation is at least partially exponential or an approximation thereto.

28. The method of claim 26, in which for a plurality of the indicative values at least one of the upper and lower bound is calculated according to an exponential term.

29. The method of claim 26 in which the indicative value is a number, and for a plurality of the indicative values at least one of the upper and lower bound depends exponentially on a term dependent on the number.

30. The method of claim 26, comprising storing a database containing the information and the estimate for a plurality of mobile devices on a first network node of the location server, the processor being on a second network node, the first and second network nodes sending each other messages comprising the information or the estimates as quantised.
